(19) United States
(12) Patent Application Publication
(10) Pub. No.: US 2026/0155742 A1
(43) Pub. Date: Jun. 4, 2026

(54) CIRCUITRY AND METHOD THEREOF

(71) Applicant: Renesas Design (UK) Limited, Bourne End (GB)

(72) Inventors: Genesia BERTELLE, Germering (DE); Davide BIANCHI, Wiltshire (GB)

(73) Assignee: Renesas Design (UK) Limited, Bourne End (GB)

(21) Appl. No.: 18/910,133

(22) Filed: Oct. 9, 2024

(51) Int. Cl. H02M 3/07; H02M 1/00; H02M 1/08

(52) U.S. Cl. CPC H02M 3/07; H02M 1/0016; H02M 1/08

(57) ABSTRACT

A regulator circuit for use with circuitry is provided. The circuitry includes a switching converter. The switching converter includes, at least, a high-side switching device and a low-side switching device coupled in series between an input node at an input voltage and a reference node. The circuitry further includes a bootstrap capacitor coupled to the high-side switching device for supplying a drive voltage for operating the high-side switching device. The regulator circuit is configured to regulate charging of the bootstrap capacitor during a time period when the high-side switching device is turned on, so as to compensate for a voltage drop across the bootstrap capacitor resulting from the high-side switching device being turned on.

### TECHNICAL FIELD

The present disclosure is generally directed to techniques related to the area of current mode switching power converters, and more particularly to techniques related to regulating bootstrap capacitor voltages in such power converters.

### BACKGROUND

The present disclosure generally relates to the area of switching power converters, such as, without intended limitation, buck converters, boost converters, buck-boost converters, integrated voltage regulators (IVRs), multi-level IVRs (MLIVRs), or the like.

A typical power regulator (or power converter) may be understood to comprise a high-side switching device, such as a power field-effect transistor (FET) or the like, and a low-side switching device. The high-side power FET may be understood to be responsible providing power to the load in a switched manner. The high-side FET is typically connected between an input voltage and the load. Often, this high-side power FET may be implemented as an NMOS transistor. Nevertheless, as can also be understood and appreciated by the skilled person, any other suitable implementation may be used as well for the high-side/low-side switching device, depending on various circumstances and/or requirements.

In addition, a bootstrap circuit may be commonly employed so as to generate the required high-side gate drive voltage to turn on the NMOS. Generally speaking, the bootstrap circuit may be understood to ensure efficient switching of the high-side power FET for example by providing a controlled voltage that is higher than the input voltage. As such, a bootstrap capacitor may be understood to represent a crucial component in the bootstrap circuit. This capacitor is typically connected between the high-side FET's gate driver supply and the high-side FET's source. In particular, the bootstrap capacitor is configured to store charge to generate the necessary gate drive voltage for the high-side FET.

In conventional practice, a diode or a switch is typically connected in series with the bootstrap capacitor during the low-side FET's conduction phase, so that the input voltage may charge the bootstrap capacitor via the diode (or the switch). This charging action generally builds up the necessary voltage across the bootstrap capacitor. Accordingly, the voltage across the bootstrap capacitor may then be used as the gate driver supply for the high-side FET. That is, when the high-side FET needs to turn on, the gate voltage is driven high, allowing the high-side FET to conduct. An illustrative, non-limiting example for an example of a conventional bootstrap-based power converter implementation is schematically shown in FIG. 1.

Generally speaking, in conventional circuit implementations, VREF is typically the desired gate-source voltage of the high-side NMOS. In many applications, VREF can be connected to VIN. Notably, in some possible cases where several high-side NMOS-based FETs may be connected in series, VREF may be lower than VIN.

Dimensioning the bootstrap capacitor for switching regulators may involve considering various factors such as the required gate charge, switching frequency, voltage ripple tolerance, allowable voltage drop across the capacitor, or the like. In particular, a general process to dimension the bootstrap capacitor may involve (but certainly not limited to):
calculating or obtaining the gate charge specification for the high-side power FET used in the switching regulator;
ensuring that the bootstrap capacitor has enough time to recharge between switching cycles; and
determining the allowable voltage ripple on the bootstrap capacitor during the switching cycle.

Notably, this tolerance may depend on the gate voltage requirements of the high-side FET and the gate driver's capabilities. That is to say, a lower voltage ripple may result in better gate drive performance but may require a larger capacitor.

As can be generally understood and appreciated by the skilled person, a formula to determine the value of the bootstrap capacitor may be formulated as follows:

$${C}_{BOOTSTRAP} = Q / Δ V , \qquad ( 1 )$$

where
Q denotes the gate charge (Coulombs), and
ΔV denotes the voltage ripple tolerance (V).

From the above formula, it may be understood that the sizing of C_{BOOTSTRAP} should be large enough to guarantee a reliable drive of the high-side switch. Accordingly, it may be seen that one of the disadvantages of this conventional approach is a large C_{BOOTSTRAP} being required. Furthermore, also because increased integration is desired, integrating this large C_{BOOTSTRAP} may in turn result in a larger die area.

In view thereof, there appears to exist a need for an improved implementation or mechanism that can overcome some or all of the above-illustrated problems associated with conventional techniques; and more particularly, that can lead to a decrease in internal bootstrap capacitance and consequently in area in the design and implementation of the switching regulators/converters.

### SUMMARY

In view of some or all of the above-illustrated technical problems, the present disclosure generally provides a regulator circuit and a corresponding method for operating such a regulator circuit, having the features of the respective independent claims.

According to an aspect of the disclosure, there is provided a regulator (or converter) circuit (sometimes also referred to as a circuit assembly, circuity, or the like). This regulator circuit may be for use with a circuitry that comprises a switching converter (or regulator) and further comprises a bootstrap capacitor. The switching converter may itself comprise at least a high-side switching device (e.g., an FET or the like, more particularly, an NMOS FET) and a low-side switching device coupled in series between an input node at an input voltage (e.g., VIN) and a reference node (e.g., ground/GND, or any other suitable reference node). Accordingly, the bootstrap capacitor may be configured to be coupled to the high-side switching device for supplying a drive voltage for operating the high-side switching device.

In particular, the regulator circuit may be configured to regulate charging (and possibly also re-charging) of the bootstrap capacitor during a time period when the high-side switching device is turned on, so as to compensate for a voltage drop across the bootstrap capacitor resulting from the high-side switching device being turned on (i.e., being in a conducting state).

Configured as such, broadly speaking, the present disclosure generally seeks to decrease the internal bootstrap capacitance and consequently the overall die area, thereby overcoming conventional switching regulator techniques that require high output currents resulting in the switching devices and consequently the bootstrap capacitor (for the high-side switches) being very large which in turn further results in a significant impact on the silicon area. In particular, it is noted that techniques/mechanisms proposed in the present disclosure may result in space saving in compact or space-constrained designs where minimizing the footprint is crucial. At the same time, the design process may be simplified, as there is generally no need to route additional connections for the external capacitor. Further, reliability associated with poor solder joints, mechanical stress, parasitic inductance or resistance in the external trace could be improved. Moreover, the internal capacitor may also lower component costs, assembly costs and eventually result in the overall cost of the regulator being reduced. Additionally, by using the proposed regulator techniques of the present disclosure, much more precise control over the charging voltage can be achieved. Yet further, it is also possible to adjust the rising edge of the gate drive voltage balancing the maximum charge current. Incidentally, it may also be worth noting that, techniques/mechanisms proposed in the present disclosure may be applied to any suitable switching converter/regulator designs, which may include (but certainly not limited to) buck, boost, buck-boost converters, IVRs, or the like. Of course, as may be understood and appreciated by the skilled person, the present disclosure may be applied to MLIVR as well, i.e., IVRs with more than one high/low-side switching device (e.g., 2 high-side devices in series and 2 low-side devices in series, or the like).

In some example embodiments, the regulator circuit may be configured to, when the high-side switching device is turned on, generate a control pulse of a variable duration, so as to couple the drive voltage to a supply voltage that is higher than the input voltage during the pulse duration.

In some example embodiments, the regulator circuit may comprise a switching device coupled between the supply voltage and the bootstrap capacitor. Particularly, this switching device may be controlled (e.g., by a suitable control logic, or the like) to be turned on (conducting) or off (non-conducting) based on the generated pulse.

In some example embodiments, the regulator circuit may be configured to adjust the pulse duration based on a (e.g., pre-determined or pre-configured) reference voltage.

In some example embodiments, the regulator circuit may be configured to adjust the pulse duration based on a voltage across the bootstrap capacitor when the high-side switching device is turned on.

In some example embodiments, the regulator circuit may be configured to adjust the pulse duration to further compensate for process and/or temperature variations. That is to say, according to the techniques proposed in the present disclosure, the accuracy of the voltage across the bootstrap capacitor would not be affected by variation (process/temperature) of the high-side switching device(s) and variation of the bootstrap capacitor, as the proposed regulator circuit can be configured to self-adjust the pulse length to compensate for these variations.

In some example embodiments, the regulator circuit may comprise a comparator module configured to take a voltage across the bootstrap capacitor and a reference voltage as inputs and generate a comparator output.

In some example embodiments, the regulator circuit may further comprise a latch module configured to latch the comparator output when the low-side switching device is turned off (non-conducting).

In some example embodiments, the regulator circuit may further comprise an offset compensating module coupled between the reference voltage and the respective input of the comparator module. In particular, the offset compensating module may be configured to compensate for a voltage drop across the low-side switching device when the low-side switching device is turned on.

In some example embodiments, the regulator circuit may further comprise a bidirectional synchronous counter module configured to count up or down in accordance with (or based on) the comparator output.

In some example embodiments, if the comparator output indicates the drive voltage being higher than the reference voltage, the bidirectional synchronous counter module may be configured to decrease its output. Similarly, if the comparator output indicates the drive voltage being lower than the reference voltage, the bidirectional synchronous counter module may be configured to increase its output.

In some example embodiments, the regulator circuit may further comprise a pulse generator module configured to generate a control pulse having a duration that is determined based on an output of the bidirectional synchronous counter module.

In some example embodiments, the control pulse may be synchronized with an input control signal of the high-side switching device, such that the control pulse is generated during the time period when the high-side switching device is turned on.

In some example embodiments, the regulator circuit may further comprise a switch driver module comprising a chain of serially connected inverting stages (e.g., inverters or the like). In particular, the switch driver module may be coupled to an output of the pulse generator module and further to a supply voltage higher than the input voltage.

In some example embodiments, the regulator circuit may yet further comprise a control module configured to control operations of the comparator module, the bidirectional synchronous counter module, the pulse generator module, and/or the switch driver module.

According to another aspect of the present disclosure, there is provided a method of operating a regulator circuit as illustrated in the preceding aspect and the associated example embodiments.

In particular, as illustrated above, this regulator circuit may be configured to be used with a circuitry that comprises a switching converter/regulator and a bootstrap capacitor. The switching converter may itself comprise at least a high-side switching device (e.g., an FET or the like, more particularly, an NMOS FET) and a low-side switching device coupled in series between an input node at an input voltage (e.g., VIN) and a reference node (e.g., ground/GND, or any other suitable reference node). Accordingly, the bootstrap capacitor may be configured to be coupled to the high-side switching device for supplying a drive voltage for operating the high-side switching device.

In particular, the method may comprise regulating charging (and possibly also re-charging) of the bootstrap capacitor during a time period when the high-side switching device is turned on, so as to compensate for a voltage drop across the bootstrap capacitor resulting from the high-side switching device being turned on (i.e., in a conducting state).

Configured as such, broadly speaking, the present disclosure generally seeks to decrease the internal bootstrap capacitance and consequently the overall die area, thereby overcoming conventional switching regulator techniques that require high output currents resulting in the switching devices and consequently the bootstrap capacitor (for the high-side switches) being very large which in turn further results in a significant impact on the silicon area. In particular, it is noted that techniques/mechanisms proposed in the present disclosure may result in space saving in compact or space-constrained designs where minimizing the footprint is crucial. At the same time, the design process may be simplified, as there is generally no need to route additional connections for the external capacitor. Further, reliability associated with poor solder joints, mechanical stress, parasitic inductance or resistance in the external trace could be improved. Moreover, the internal capacitor may also lower component costs, and assembly costs and eventually result in the overall cost of the regulator being reduced. Additionally, by using the proposed regulator techniques of the present disclosure, much more precise control over the charging voltage can be achieved. Yet further, it is also possible to adjust the rising edge of the gate drive voltage balancing the maximum charge current. Incidentally, it may also be worth noting that, techniques/mechanisms proposed in the present disclosure may be applied to any suitable switching converter/regulator designs, which may include (but certainly not limited to) buck, boost, buck-boost converters, IVRs, or the like. Of course, as may be understood and appreciated by the skilled person, the present disclosure may be applied to MLIVR as well, i.e., IVRs with more than one high/low-side switching device (e.g., 2 high-side devices in series and 2 low-side devices in series, or the like).

Details of the disclosed method may be implemented as systems (e.g., in the form of circuit, circuitry, circuit assembly, or the like) adapted to execute some or all of the steps of the method, and vice versa, as the skilled person will appreciate. In particular, it is understood that methods according to the disclosure relate to methods of operating the systems (or circuit, circuitry, circuit assembly, etc.) according to the above embodiments and variations thereof and that respective statements made with regard to the systems likewise apply to the corresponding methods, and vice versa.

It is also understood that in the present disclosure, the term “couple” or “coupled” refers to elements being in electrical communication with each other, whether directly connected e.g., via wires or in some other manner (e.g., indirectly). Notably, one example of being coupled is being connected.

### BRIEF DESCRIPTION OF THE DRAWINGS

Example embodiments of the disclosure are explained below with reference to the accompanying drawings, wherein like reference numbers may indicate like or similar elements, and wherein

FIG. 1 schematically illustrates an example of a possible implementation of a bootstrap-capacitor-based power regulator;

FIG. 2 schematically illustrates an example of a possible implementation of a regulator circuit according to embodiments of the present disclosure;

FIG. 3 schematically illustrates an example of a voltage diagram across the bootstrap capacitor in the regulator circuit according to embodiments of the present disclosure;

FIG. 4 schematically illustrates example waveform diagrams of signals of the regulator circuit according to the example of FIG. 2; and

FIG. 5 is a flowchart schematically illustrating an example of a method of operating a regulator circuit according to embodiments of the present disclosure.

### DETAILED DESCRIPTION

As indicated above, identical or like reference numbers in the present disclosure may, unless indicated otherwise, indicate identical or like elements, such that repeated descriptions thereof may be omitted for reasons of conciseness.

As briefly mentioned above, broadly speaking, this present disclosure generally relates to the technical area of (e.g., current mode) switching power converters/regulators, such as buck, boost, buck-boost converters, integrated voltage regulators (IVRs), multi-level IVRs (MLIVRs), or the like.

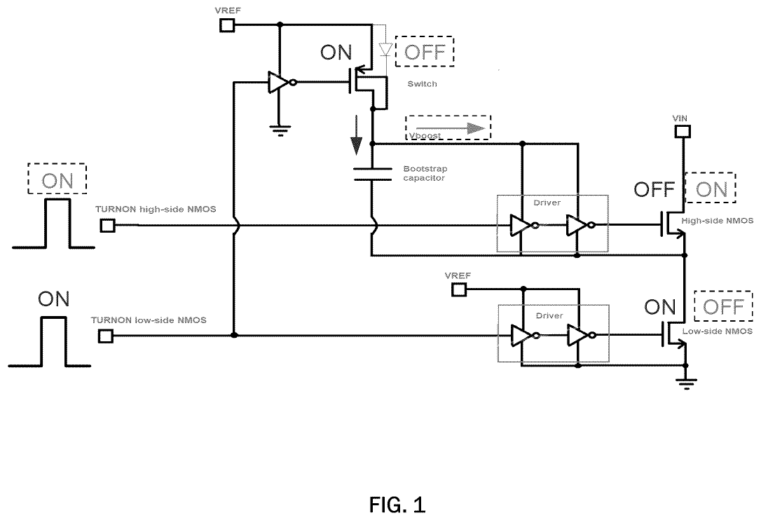

As illustratively shown for example in FIG. 1, a typical power regulator/converter may consist of a high-side switching device (e.g., a field-effect transistor (FET) or the like) and a low-side switching device. The high-side power FET may be understood to be responsible for switching the power to the load. The high-side FET is typically connected between an input voltage and a load. Often this high-side power FET may be implemented as an NMOS transistor. Nevertheless, as can also be understood and appreciated by the skilled person, any other suitable implementation may be used as well for the high-side/low-side switching device, depending on various circumstances and/or requirements.

In addition, a bootstrap circuit may be commonly employed so as to generate the required high-side gate drive voltage to turn the NMOS on. Generally speaking, the bootstrap circuit may be understood to ensure efficient switching of the high-side power FET for example by providing a controlled voltage that is higher than the input voltage. As such, a bootstrap capacitor may be understood to represent a crucial component in the bootstrap circuit. This capacitor is typically connected between the high-side FET's gate driver supply and the high-side FET's source. In particular, this bootstrap capacitor is configured to store charge to generate the necessary gate drive voltage for the high-side FET.

Moreover, a switch (or a diode) may be connected in series with the bootstrap capacitor during the low-side FET's conduction phase, such that the input voltage may charge the bootstrap capacitor through the switch (or the diode). This charging action generally builds up the necessary voltage across the bootstrap capacitor. Accordingly, the voltage across the bootstrap capacitor may then be used as the gate driver supply for the high-side FET. That is, when the high-side FET needs to turn on, the gate voltage is driven high, allowing the high-side FET to conduct.

As illustrated above, dimensioning the bootstrap capacitor for switching regulators may involve considering various factors such as the required gate charge, switching frequency, voltage ripple tolerance, allowable voltage drop across the capacitor, or the like. In particular, a general process to dimension the bootstrap capacitor may involve (but certainly not limited to): calculating or obtaining the gate charge specification for the high-side power FET used in the switching regulator; ensuring that the bootstrap capacitor has enough time to recharge between switching cycles; and determining the allowable voltage ripple on the bootstrap capacitor during the switching cycle. Notably, this tolerance may depend on the gate voltage requirements of the high-side FET and the gate driver's capabilities. That is to say, a lower voltage ripple may result in better gate drive performance but may require a larger capacitor.

According to the above formula (1), it may be generally understood that the sizing of the bootstrap capacitor should be large enough to guarantee a reliable drive of the high-side switch. Accordingly, it may be seen that one of the disadvantages of this conventional approach is a large bootstrap capacitor being required. Furthermore, also because increased integration is desired, integrating this large bootstrap capacitor may in turn result in a larger die area.

In view thereof, generally speaking, the present disclosure seeks to propose techniques and/or mechanisms that can overcome some or all of the above-illustrated problems associated with conventional techniques; and more particularly, that can lead to a decrease in internal bootstrap capacitance and consequently in area in the design and implementation of the switching regulators/converters.

As will become apparent in the below description, techniques proposed in the present disclosure may bring at least the following advantages:
Space saving in compact or space-constrained designs where minimizing the footprint is crucial.
Simplified Design. In fact, there is no need to route additional connections for the external capacitor.
Improved reliability associated with poor solder joints, mechanical stress, parasitic inductance or resistance in the external trace.
The internal capacitor can reduce the overall cost of the regulator, and lower component costs and assembly costs.

Moreover, by using this special regulator circuit as proposed, much more precise control over the charging voltage can be achieved. In addition, it is also possible to adjust the rising edge of the gate drive voltage balancing the maximum charge current.

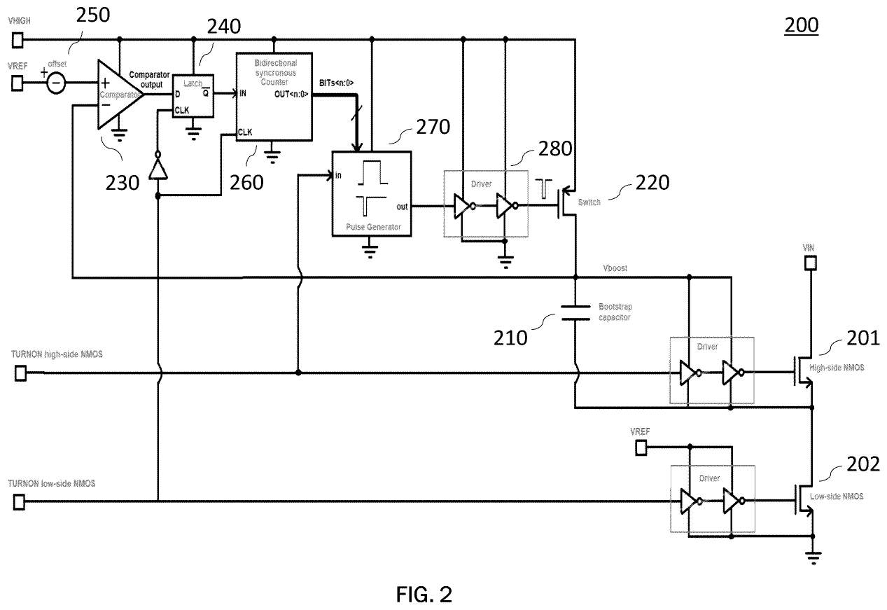

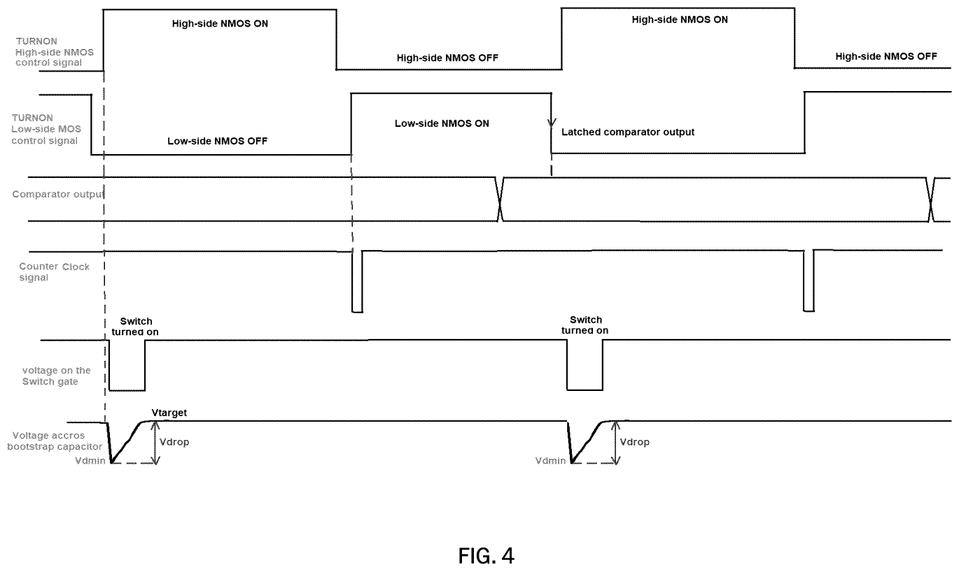

Reference is now made to the illustrative example as shown in FIG. 2, which schematically illustrates an example of a possible implementation of a regulator circuit 200 according to embodiments of the present disclosure. For the sake of easy understanding, FIG. 4 schematically illustrates example waveform diagrams of signals of the regulator circuit of FIG. 2 during operation.

As a brief recap, as mentioned above, a conventional high-side driver circuit may typically employ a bootstrap capacitor (denoted as “C_{BOOTSTRAP}”) to provide energy to the high-side transistor driver. Specifically, the bootstrap capacitor may be discharged when the high-side switch is turned ‘ON’ (conducting) and recharged during the period when the high-side switch is ‘OFF’ (non-conducting) and the low-side switch is turned ‘ON’. Further, the charging to the bootstrap capacitor is not tightly controlled, resulting in the need to over-size the bootstrap capacitor to allow for the reliable drive of the high-side switch.

In contrast, techniques proposed by the present disclosure generally allow for the intelligent charging of the bootstrap capacitor, including charging the bootstrap capacitor while the high-side switch is ON. As a consequence, this allows for a reduced C_{BOOTSTRAP} size while still providing a reliable drive of the high-side switch.

Generally speaking, the formula for determining C_{BOOTSTRAP} is the same as shown in formula (1) above. But since in the present disclosure, the voltage drop (denoted as “V_{DROP}”) may be much larger, C_{BOOTSTRAP} can be much smaller. This may be illustrated by using the following formula (2), namely

$${C}_{BOOTSTRAP} = Q / {V}_{DROP} , \qquad ( 2 )$$

where V_{DROP}(prior art) >>V_{DROP}(present disclosure).

In short, the present disclosure generally seeks to propose a regulator/converter that is capable of maintaining the voltage across the bootstrap capacitor at the desired value, allowing the bootstrap capacitor to be reduced in comparison with conventional circuits. Specifically, in the example implementation of the regulator circuit 200 as shown in FIG. 2, the bootstrap capacitor 210 is connected between the gate driver supply of the high-side switching device (e.g., N-MOSFET) 201 and the source of the high-side switching device 201.

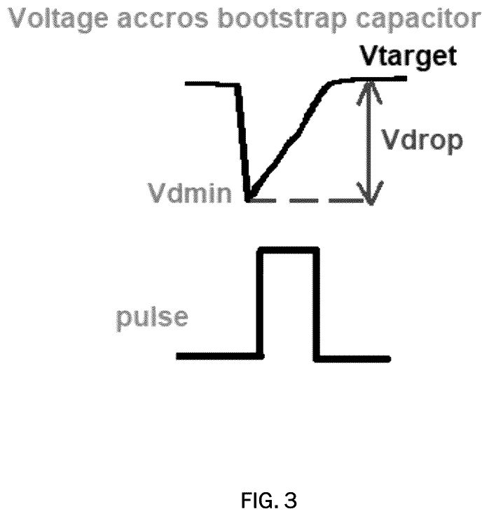

To be more specific, when the high-side switching device 201 is switched ‘ON’, the gate capacitor of this switching device may parallel the charged bootstrap capacitor 210. Charge redistribution occurs between these two capacitors, causing the gate drive voltage to decrease and drop down to Vdmin. A schematic example showing such voltage drop is illustratively shown in FIG. 3. As can be understood and appreciated by the skilled person, such voltage drop may be expressed as:

$${V}_{DROP} = {C}_{GATE} / ( {C}_{GATE} + {C}_{BOOTSTRAP} ) , \qquad ( 3 )$$

where
V_{DROP} denotes the voltage drop of the gate driver voltage when the high-side switching device turns ON, and
C_{GATE} denotes the gate capacitor of the high-side switching device (e.g., N-MOSFET).
In conventional implementations, Vdmin may be typically set by the voltage ripple requirement. In the present disclosure, the bootstrap capacitor can be decreased and designed to ensure only that Vdmin is higher than the minimum gate-source voltage required to turn on the high-side N-MOSET. This has to be guaranteed under all conditions, regardless of process and/or temperature variations.

In simple words, the regulator circuit proposed in the present disclosure is employed to provide the charging voltage for the bootstrap capacitor to compensate for this voltage drop as fast as possible.

To be more specific, with reference to the example circuit 200 of FIG. 2, when the high-side power N-MOSFET 201 is switched on, the circuit may be configured (e.g., by a control logic or the like, not shown in the figures) to generate a pulse of variable size which turns on a switch 220 (e.g., implemented as a P-MOSFET or the like) and connects the gate drive voltage to a supply voltage VHIGH (higher than the input voltage VIN). It may be worth mentioning that, unless indicated otherwise, the term “pulse size” may be used herein interchangeably with similar terms such as “pulse length”, “pulse width”, “pulse duration”, or the like, as will also be clearly understood and appreciated by the skilled person.

This higher voltage can be provided from an external rail or internal charge pump, depending on various implementations and/or requirements. Generally speaking, it should be higher than the bootstrapped supply reference voltage plus the VIN voltage.

The pulse width may be adjusted by the regulator circuit so that the bootstrap capacitor is charged to the desired drive voltage. Since the charging current may be typically limited by the Rds-On of the switch 220, the faster the gate drive voltage rises, the lower the Rds-On of the switch 220 needs to be. Generally speaking, the average charge current is proportional to the switching frequency and to the pulse duration. As a result, it may be understood that it would be necessary to find a right compromise between the rising edge of the gate drive voltage and the maximum average charge current, for example by increasing or decreasing the Rds-On of the switch 220.

The regulator circuit may be configured to define the pulse duration, thereby allowing precise control over the bootstrap charging voltage. Accordingly, as shown in the example implementation of FIG. 2, the regulator circuit 200 may comprise a (stable) voltage reference VREF to operate and a comparator module 230.

More particularly, the comparator module may be configured to compare the drive voltage Vboost with the voltage reference VREF (the respective “Comparator output” and its respective waveform are also illustratively shown in FIGS. 2 and 4, respectively). Generally speaking, this comparison is made when the high-side power MOSFET 201 is switched off and the low-side power MOSFET 202's source is at a low voltage.

The comparator output voltage is then latched (e.g., by using a latch module 240 or the like) when the control signal of the low-side NMOS 202 (see the respective waveform “Low-side NMOS control signal” in FIG. 4) falls (or in other words, when the low-side NMOS 202 turns off). In general, the comparator 230 needs to respond within the low-side power MOSFET minimum on time. It is nevertheless noted that the speed of the comparator 230 is not particularly critical in applications in which the switching regulator is working at a low duty cycle.

In some possible implementations, during the comparison process, some sort of offset 250 (e.g., by using an offset compensating module or the like) may be applied at the respective input of the comparator 230, in order to compensate for the drop across the low-side NMOS transistor. The main reason is that when the comparator 230 compares the voltage on the bootstrap capacitor 210 with the reference voltage VREF when the low-side transistor 202 is on, the voltage at the input of the comparator may be generally seen as the sum of the voltage on the bootstrap capacitor and the low-side IR drop. In order to eliminate this error, an offset of an equal value of the low-side IR drop may be added to the comparator's reference voltage. This compensation will help to have a high enough Vgs drive voltage of the high-side NMOS 201 to have the lowest possible Rds-On.

In some possible examples, this offset may for example be built like an NMOS of the same type of the low-side NMOS and a current proportional to the output current, or any other suitable type of circuit generating a voltage proportional to the drop across the low-side NMOS transistor. Of course, any other suitable implementation may be adopted as well, depending on various circumstances and/or requirements.

As shown in the example implementation of FIG. 2, the regulator circuit 200 also comprises a bidirectional synchronous counter module 260 that may be configured to count up or down depending on the comparator output voltage and its flip-flops change their states synchronously with a clock. In particular, if the comparator 230 measures a drive voltage higher than the target, the counter output will decrease. Conversely, if the drive voltage is lower, the counter output will increase. Specifically, the clock latches the counter when the low-side power MOSFET 202 turns on (see for example also the waveform of the “Counter clock” signal in FIG. 4). Further, in some possible implementations, a same or separate control logic (not shown in the figures) may be adopted to ensure that even if the counter reaches full scale or minimum code (e.g., “11111” or “000000”, or the like, depending on various implementations of the bidirectional synchronous counter 260), the counter output will remain the same, i.e., it will not reset.
The regulator circuit 200 further comprises a pulse generator module 270 that may be configured to create a pulse of a size determined by the counter output bits (see for example also the waveform of the “voltage on the switch gate” as shown in FIG. 4). The pulse may be synchronized with the high-side NMOS control signals. In some possible implementations, the maximum pulse size may be obtained when the counter output also reaches its maximum (e.g., “11111” or the like); and similarly, the minimum size may be obtained when the counter output reaches its minimum (e.g., “00000” or the like). As can be understood and appreciated by the skilled person, there may be various suitable circuit implementations for a pulse generator capable of generating variable sizes. For instance, in some possible (non-limiting) examples, the pulse generator 270 could consist of several logic gates and the size can be determined by the Rds-On of an FET and/or a variable capacitance, or a voltage-controlled resistor. In some other possible (non-limiting) examples, the pulse generator 270 could include a timing circuit that may be configured to determine the pulse width, with digital control mechanisms, such as programmable logic devices, or the like. In some further possible (non-limiting) examples, the pulse generator may also be implemented for example by using variable fingers with a fixed size.

In addition, the regulator circuit 200 may further comprise a switch driver module (or circuit) 280. The switch driver module/circuit 280 may be implemented as a chain of inverters (or in any other suitable form serving as inverting stages), for example built with respective transistors supporting the highest voltage rail. In some cases, the switch-driver delay may be considered critical for the circuit functionality. Accordingly, in order to compensate for this switch-driver delay, in some possible implementations, the control input of the high-side NMOS driver (see for example the “TURNON High-side NMOS control signal” and its respective waveform illustratively shown in FIGS. 2 and 4, respectively) can be used as input to generate the pulse. In this way, the switch-driver delay of the bootstrap capacitor 210 plus the delay of the pulse generator 270 may be used for compensating (or partially compensating) the propagation time of the driver circuit 280 of the high-side NMOS 201. Accordingly, the switch 220 may be configured to load the bootstrap capacitor 210 and increase the voltage across it as soon as possible after the high-side NMOS 201 is turned on. This minimizes the V_{DROP} in both voltage and duration.

As may be understood and appreciated by the skilled person, the accuracy of the voltage across the bootstrap capacitor 210 may be determined by the accuracy of the pulse created and the accuracy of the voltage reference. In particular, the accuracy of the pulse is affected by process variation and temperature. However, the accuracy of the voltage across the bootstrap capacitor 210 is not affected by variation (process/temperature) of the high-side power FET 201 and variation of the bootstrap capacitor 210, since, as illustrated earlier, the proposed regulator circuit 200 can be configured to adjust the pulse length (width) to compensate for those variations.

In some further possible examples, some sort of enable and protection circuitry or the like could also be included to ensure a safe and reliable operation of the overall circuit.

To summarize the above, by using the regulator circuit techniques proposed in the present disclosure, precise control over the charging voltage can be achieved. In particular, the control logic(s) (not shown in the figures), the counter module 260, comparator module 230, and the driver circuit 280 work together to regulate the charging process and maintain the desired voltage across the bootstrap capacitor 210. In consequence, this ensures a reliable and efficient operation of the high-side power MOSFET 201 in the switching regulator, thereby reducing both the integrated bootstrap capacitor value and the corresponding die area. In addition to greatly decreasing the bootstrap capacitance, the proposed techniques also regulate the Vgs voltage of the high-side NMOS 201 accurately and are at the same time insensitive to variations in VIN, load current, and Rds-On of the low-side NMOS 202 (e.g., by implementing the comparator offset 250 as illustrated earlier).

As illustrated above also, the regulator circuit techniques proposed in the present disclosure may be used in any type of switching regulator (even with several NMOS high-sides in series), which may include, but certainly not limited to, buck, boost, buck-boost converters, IVRs, or the like. Of course, as may be understood and appreciated by the skilled person, the present disclosure may be applied to MLIVR as well, i.e., IVRs with more than one high/low-side switching device (e.g., 2 high-side devices in series and 2 low-side devices in series, or the like).

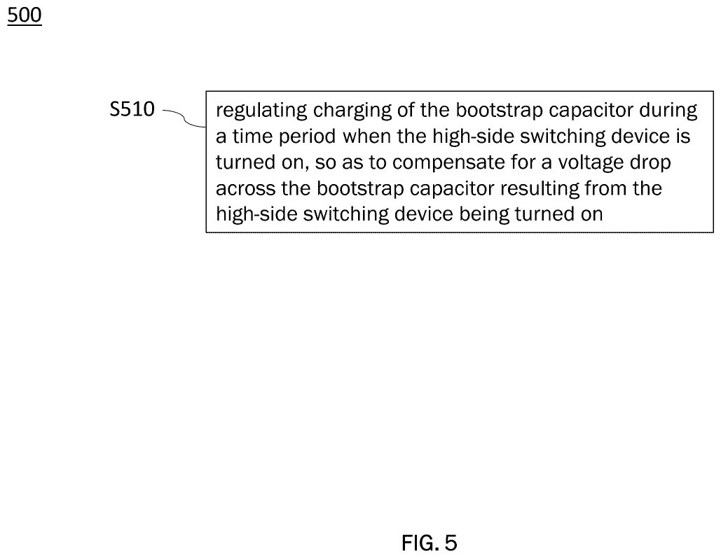

Finally, a flowchart illustrating an example of a method 500 of operating a regulator circuit is schematically shown in FIG. 5. The regulator circuit may be implemented in accordance with the possible embodiments as described above with respect to FIG. 2, or the like.

For example, this regulator circuit may be for use with a circuitry that comprises a switching converter (or regulator) and further comprises a bootstrap capacitor. The switching converter may itself comprise a high-side switching device (e.g., an FET or the like, more particularly, an NMOS FET) and a low-side switching device coupled in series between an input node at an input voltage (e.g., VIN) and a reference node (e.g., ground/GND, or any other suitable reference node). Accordingly, the bootstrap capacitor may be configured to be coupled to the high-side switching device for supplying a drive voltage for operating the high-side switching device.

In particular, method 500 may comprise, at step S510, regulating charging (and possibly also re-charging) of the bootstrap capacitor during a time period when the high-side switching device is turned on, so as to compensate for a voltage drop across the bootstrap capacitor resulting from the high-side switching device being turned on (i.e., in a conducting state).

Configured as such, broadly speaking, the present disclosure generally seeks to decrease the internal bootstrap capacitance and consequently the overall die area, thereby overcoming conventional switching regulator techniques that require high output currents resulting in the switching devices and consequently the bootstrap capacitor (for the high-side switches) being very large which in turn further results in a significant impact on the silicon area. In particular, it is noted that techniques/mechanisms proposed in the present disclosure may result in space saving in compact or space-constrained designs where minimizing the footprint is crucial. At the same time, the design process may be simplified, as there is generally no need to route additional connections for the external capacitor. Further, reliability associated with poor solder joints, mechanical stress, parasitic inductance or resistance in the external trace could be improved. Moreover, the internal capacitor may also lower component costs, and assembly costs and eventually result in the overall cost of the regulator being reduced. Additionally, by using the proposed regulator techniques of the present disclosure, much more precise control over the charging voltage can be achieved. Yet further, it is also possible to adjust the rising edge of the gate drive voltage balancing the maximum charge current.

It should be noted that the circuit/system features described above correspond to respective method features that may however not be explicitly described, for reasons of conciseness. The disclosure of the present document is considered to extend also to such method features. In particular, the present disclosure is understood to also relate to methods of manufacturing and/or operating the circuits described above, and/or to providing and/or arranging respective elements of these circuits.

It should also be noted that the disclosed example embodiments can be implemented in many ways using hardware and/or software configurations. For example, the disclosed embodiments may be implemented using dedicated hardware, dedicated software, and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

Finally, it should be noted that the description and drawings merely illustrate the principles of the proposed circuits and methods. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed method. Furthermore, all statements herein providing principles, aspects, and embodiments of the invention, as well as specific examples thereof, are intended to encompass equivalents thereof.

1. A regulator circuit for use with circuitry that comprises a switching converter comprising at least a high-side switching device and a low-side switching device coupled in series between an input node at an input voltage and a reference node, and further comprises a bootstrap capacitor coupled to the high-side switching device for supplying a drive voltage for operating the high-side switching device,
wherein the regulator circuit is configured to regulate charging of the bootstrap capacitor during a time period when the high-side switching device is turned on, so as to compensate for a voltage drop across the bootstrap capacitor resulting from the high-side switching device being turned on.

2. The regulator circuit according to claim 1, wherein the regulator circuit is configured to, when the high-side switching device is turned on, generate a control pulse of a variable duration, so as to couple the drive voltage to a supply voltage higher than the input voltage during the pulse duration.

3. The regulator circuit according to claim 2, wherein:
the regulator circuit comprises a further switching device coupled between the supply voltage and the bootstrap capacitor; and
the further switching device is controlled to be turned on or off based on the generated control pulse.

4. The regulator circuit according to claim 2, wherein the regulator circuit is configured to adjust the pulse duration based on a reference voltage.

5. The regulator circuit according to claim 2, wherein the regulator circuit is configured to adjust the pulse duration based on a voltage across the bootstrap capacitor when the high-side switching device is turned on.

6. The regulator circuit according to claim 2, wherein the regulator circuit is configured to adjust the pulse duration to further compensate for process and/or temperature variations.

7. The regulator circuit according to claim 1, wherein the regulator circuit comprises a comparator module configured to take a voltage across the bootstrap capacitor and a reference voltage as inputs and generate a comparator output.

8. The regulator circuit according to claim 7, wherein the regulator circuit further comprises a latch module configured to latch the comparator output when the low-side switching device is turned off.

9. The regulator circuit according to claim 7, wherein the regulator circuit further comprises an offset compensating module coupled between the reference voltage and the respective input of the comparator module, the offset compensating module being configured to compensate for a voltage drop across the low-side switching device when the low-side switching device is turned on.

10. The regulator circuit according to claim 7, wherein the regulator circuit further comprises a bidirectional synchronous counter module configured to count up or down in accordance with the comparator output.

11. The regulator circuit according to claim 10, wherein:
if the comparator output indicates the drive voltage being higher than the reference voltage, the bidirectional synchronous counter module is configured to decrease its output; and/or
if the comparator output indicates the drive voltage being lower than the reference voltage, the bidirectional synchronous counter module is configured to increase its output.

12. The regulator circuit according to claim 10, wherein the regulator circuit further comprises a pulse generator module configured to generate a control pulse having a duration that is determined based on an output of the bidirectional synchronous counter module.

13. The regulator circuit according to claim 12, wherein the control pulse is synchronized with an input control signal of the high-side switching device, such that the control pulse is generated during the time period when the high-side switching device is turned on.

14. The regulator circuit according to claim 12, wherein the regulator circuit further comprises a switch driver module comprising a chain of serially connected inverting stages, the switch driver module being coupled to an output of the pulse generator module and to a supply voltage higher than the input voltage.

15. The regulator circuit according to claim 14, wherein the regulator circuit further comprises a control module configured to control operation of the comparator module, the bidirectional synchronous counter module, the pulse generator module, and/or the switch driver module.

16. A method of operating a regulator circuit for use with a circuitry, wherein the circuitry comprises a switching converter comprising at least a high-side switching device and a low-side switching device coupled in series between an input node at an input voltage and a reference node and further comprises a bootstrap capacitor coupled to the high-side switching device for supplying a drive voltage for operating the high-side switching device,
wherein the method comprises:
regulating charging of the bootstrap capacitor during a time period when the high-side switching device is turned on, so as to compensate for a voltage drop across the bootstrap capacitor resulting from the high-side switching device being turned on.
